(19) United States
(12) Patent Application Publication
(10) Pub. No.: US 2010/0194107 A1
(43) Pub. Date: Aug. 5, 2010

(54) TUBE FITTING

(75) Inventors: Andrew P. Marshall, University Heights, OH (US); Peter C. Williams, Cleveland Heights, OH (US); Mark A. Clason, Orwell, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, Solon, OH (US)

(21) Appl. No.: 12/671,552

(22) PCT Filed: Aug. 7, 2008
(86) PCT No.: PCT/US08/72427

§ 371 Date: Feb. 1, 2010

Related U.S. Application Data
(60) Provisional application No. 60/954,931, filed on Aug. 9, 2007.

(51) Int. Cl. F16L 19/08

(52) U.S. Cl. 285/382.7

(57) ABSTRACT

A ferrule type, flareless fitting is provided that includes a first fitting component (12), a second fitting component (16), a front ferrule (20), and a rear ferrule (22). The first fitting component comprises a rear ferrule recess and a front ferrule recess. The second fitting component includes a ferrule camming surface. The front ferrule is disposed between the first fitting component and the second fitting component such that a portion of the front ferrule engages the front ferrule camming surface. The front ferrule includes a flange that extends radially outward from a portion of the front ferrule that engages the front ferrule camming surface. A difference angle is defined between the front ferrule recess and an outer surface of the flange when the fitting is in a finger tight condition. The difference angle diminishes during pull up of the fitting. A rear ferrule is disposed between the front ferrule and the first fitting component such that a rear ferrule drive surface of the rear ferrule recess engages the rear ferrule when the fitting is pulled up.

### RELATED APPLICATIONS

This application claims the benefit of co-pending U.S. Provisional Patent Application Ser. No. 60/954,931, filed Aug. 9, 2007, for “Tube Fitting,” the disclosure of which is fully incorporated herein by reference.

### BACKGROUND OF THE INVENTION

Flareless fittings have been in use for decades for conduits such as tubes and pipes. A flareless fitting is used to connect or join two tube or pipe ends or to connect a conduit end to another assembly such as a tank, a valve, a manifold and so on. The applications are as varied as the types of assemblies with which the fittings are used. One very common type of flareless fitting is a ferrule type fitting. In a ferrule type fitting, one or more ferrules are used to join or connect a conduit end to a fitting member, typically called a fitting body. The fitting body may then be joined to (or be part of) another assembly. In a ferrule type fitting, the ferrule or ferrules must establish a fluid tight seal, particularly under pressure, as well as adequate grip of the conduit and protection against vibration. High performance fittings, such as are available from Swagelok Company, Solon, Ohio, are capable of withstanding pressures many times the rated pressure of the fitting without leaking, without adverse effects from vibration and without conduit blow out to the point that the conduit will burst before a seal is compromised or the ferrule(s) can lose their grip on the conduit.

Ferrule style fittings have an advantage over other end connections in that they do not rely on any special preparation of the tube or pipe end, other than low cost squaring and deburring. This is because the ferrules create the seals and tube grip. Flareless fittings that use ferrules are commonly used in sophisticated chemical processing apparatus because of their high reliability. For example, in the semiconductor industry, such fittings assure containment of expensive or toxic chemicals. Typically, these applications are high purity and therefore, rely on conduits made of stainless steel or other low corrosion, high strength alloys.

### SUMMARY OF THE DISCLOSURE

In accordance with an aspect of the disclosure, ferrule type, flareless fittings are provided that includes a first fitting component, a second fitting component, a front ferrule, and a rear ferrule. In one exemplary embodiment, the first fitting component comprises a rear ferrule recess and a front ferrule recess. The second fitting component includes a ferrule camming surface or mouth. The front ferrule is disposed between the first fitting component and the second fitting component such that a portion of the front ferrule engages the front ferrule camming surface. The front ferrule includes a flange that extends radially outward from a portion of the front ferrule that engages the front ferrule camming surface. A difference angle is defined between the front ferrule recess and an outer surface of the flange when the fitting is in a finger tight condition. The difference angle diminishes during pull up of the fitting. A rear ferrule is disposed between the front ferrule and the first fitting component such that a rear ferrule drive surface of the rear ferrule recess engages the rear ferrule when the fitting is pulled up.

### BRIEF DESCRIPTION OF THE DRAWINGS

These and other inventive aspects and features of the present disclosure will become apparent to one skilled in the art to which the present invention relates upon consideration of the following description of the exemplary embodiments with reference to the accompanying drawings, in which:

FIG. 1 is a longitudinal cross-section of an exemplary embodiment of a fitting in accordance with the present invention in a finger tight condition;

FIG. 1A is a view of an enlarged portion of FIG. 1;

FIG. 2 is an enlarged cross section of a first ferrule of the exemplary fitting shown in FIG. 1;

FIG. 3 is an enlarged cross section of a second ferrule of the exemplary fitting shown in FIG. 1;

FIG. 4 is a half longitudinal cross-section of the exemplary fitting shown in FIG. 1 in a pulled-up condition;

FIG. 5 is a longitudinal cross-section of another exemplary fitting of the present invention shown in a finger tight condition;

FIG. 5A is a view of an enlarged portion of FIG. 5; and

FIG. 6 is a half longitudinal cross-section of the exemplary fitting shown in FIG. 5 in a pulled-up condition.

### DETAILED DESCRIPTION OF THE EXEMPLARY EMBODIMENTS

While the inventions are described herein with specific reference to a variety of exemplary structural and material features, such descriptions are intended to be exemplary in nature and should not be construed in a limiting sense. The exemplary embodiments herein illustrate what is commonly known as a male-style fitting, meaning that a male (i.e. externally) threaded component receives and abuts the conduit end. Many inventive aspects of the disclosure will find application in female-style fittings as will be apparent to those skilled in the art. The inventions will also find application for fitting assemblies that do not require threaded connections between the fitting components, for example clamped or bolted fittings may be used. The inventions will also find application far beyond the exemplary embodiments herein as to connections that can be made to a wide and ever expansive variety of fluid components including, but not limited to, other conduits, flow control devices, containers, manifolds and so on.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

Although various embodiments are described herein with specific reference to the fitting components being made of stainless steel, such description is intended to be exemplary in nature and should not be construed in a limiting sense. Those skilled in the art will readily appreciate that the invention may be realized using any number of different types of metals material for the fitting components, as well as metal tubing materials, including but not limited to 316, 316L, 304, 304L, 6 Moly SS, any austenitic or ferritic stainless steel, any duplex stainless steel, any nickel alloy such as HASTALLOY, INCONEL, MONEL, alloy 825, alloy 625, any precipitation hardened stainless steel such as 17-4PH for example, brass, copper alloys, any carbon or low allow steel such as 12L14, 1010, 1020, 1030 steel for example. An aspect of the choice of materials is that the tube gripping device may be case or through hardened to a ratio of at least 3.3 and preferably 4 or more times as hard as the hardest tubing material that the fitting will be used with. Therefore, the tube gripping device need not be made of the same material as the tubing itself. For example, the tube gripping device may be selected from the stainless steel material noted above, or other suitable materials that can be case hardened, such as magnesium, titanium and aluminum, to name some additional examples. Any one or more of the fitting components may be hardened by a low temperature carburization process.

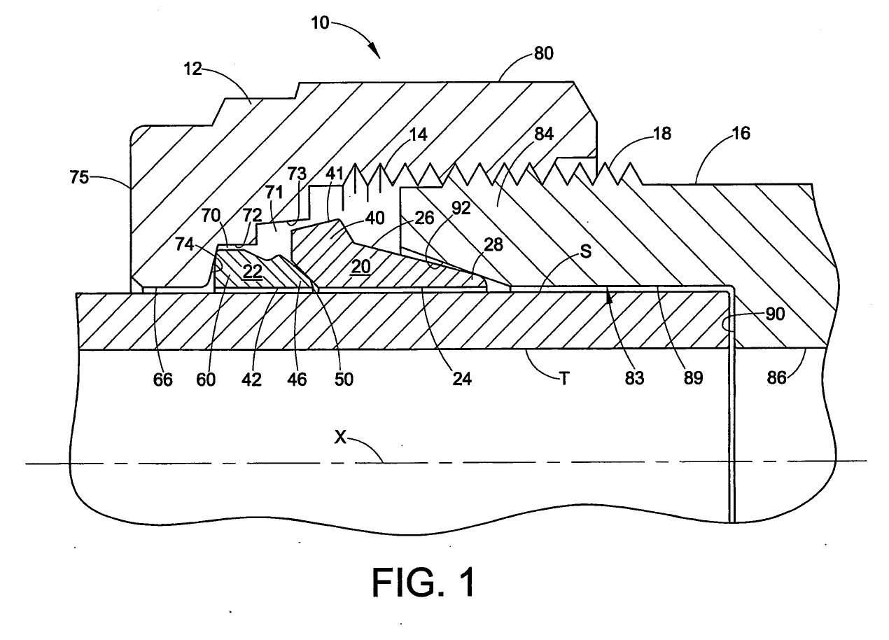

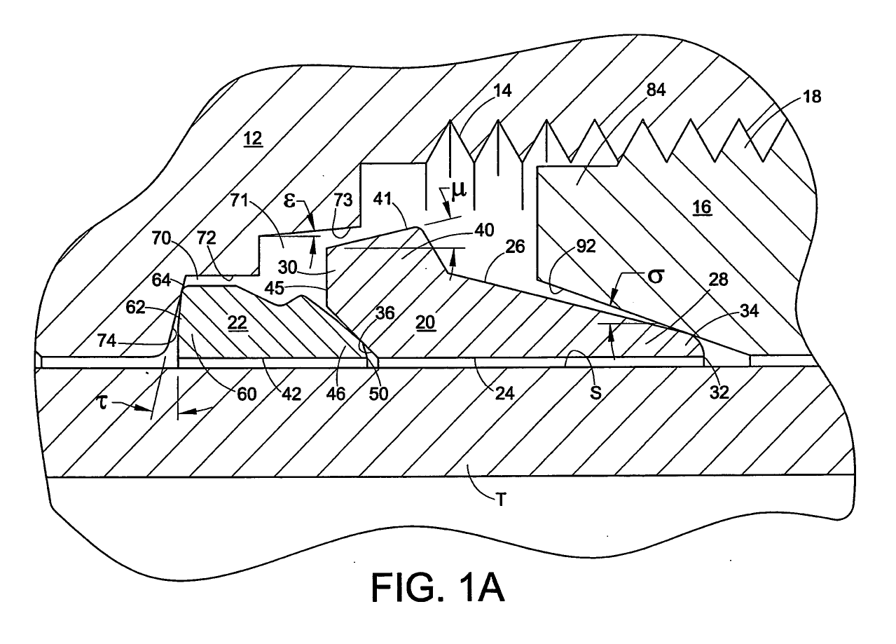

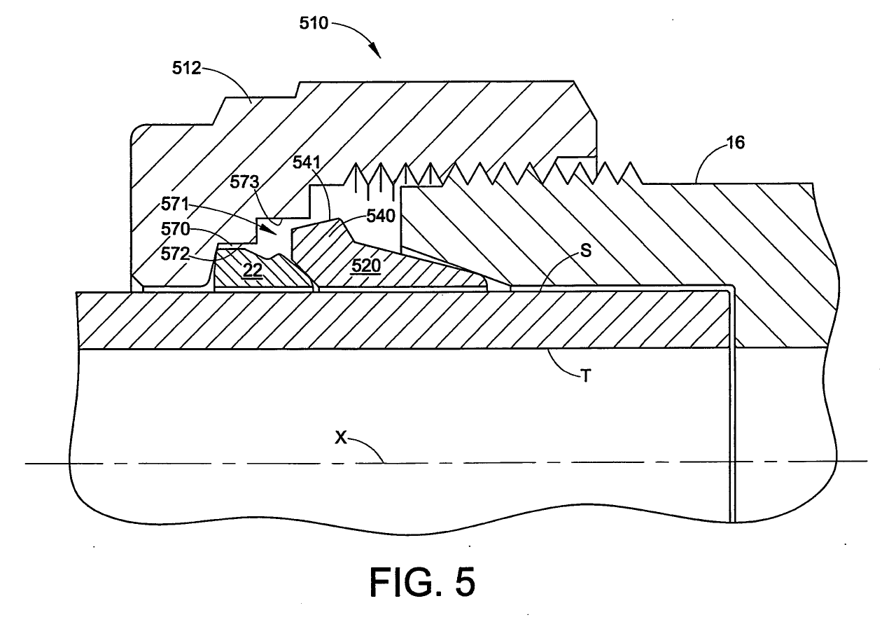

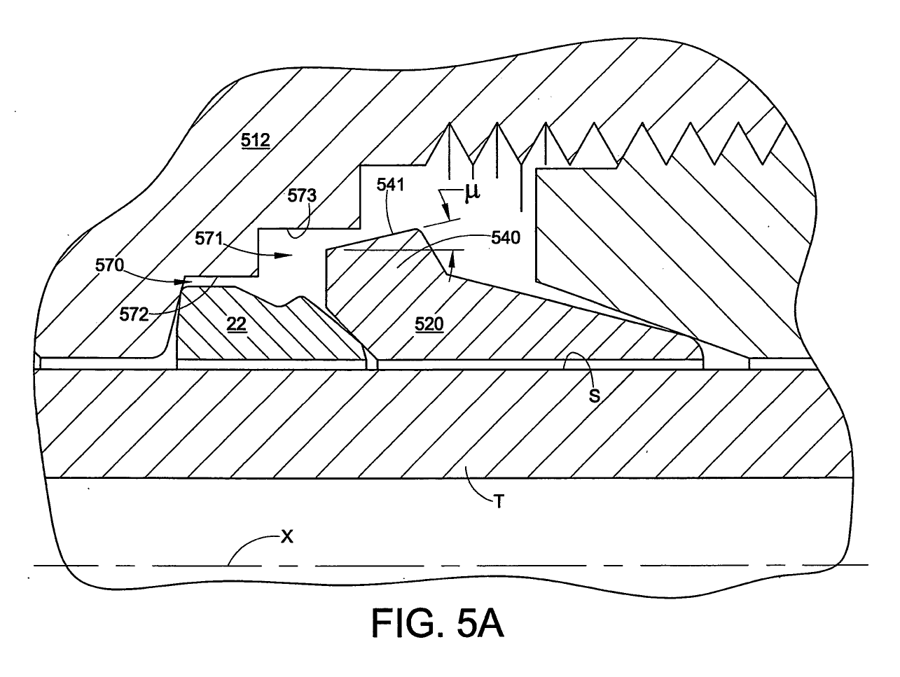

Referring to FIGS. 1 and 5, the present application discloses exemplary embodiments of fittings 10, 510 that include a front ferrule recess 71, 571 and a rear ferrule recess 70, 570. The front ferrule recesses and the front ferrules are configured such that a difference angle is presented between a radially outer surface of the front ferrule recess and the front ferrule when the fitting is in a finger tight condition and the difference angle diminishes during pull up of the fitting. FIGS. 1-6 illustrate two embodiments of fittings that include front and rear ferrule recesses and a difference angle between the front ferrule recess and the front ferrule that diminishes during pull-up. This concept may be applied to a wide variety of fittings that differ from the fittings illustrated by FIGS. 1-6. For example, the concept may be applied to fittings that include a male nut and a female body, a clamp-type fitting, or any other type of fitting.

With reference to FIG. 1, one exemplary embodiment of a fitting 10 includes a first fitting component 12 that can be realized in the form of a female threaded nut having internal threads 14. The first fitting component 12 joins or connects with a second fitting component 16 that can be realized in the form of a male threaded body having external threads 18 that threadably mate with the threads 14 of the first component 12 when the fitting 10 is made-up or assembled. Different thread options and non-threaded coupling designs may be used for the first and second fitting components.

The fitting 10 further includes a tube gripping device. Ferrules are an example of a tube gripping device and, in the example illustrated by FIG. 1, two ferrules are included; a front or first ferrule 20 and a back or second ferrule 22. The fitting, however, can be designed for using an alternative tube gripping device. The nut 16 and ferrules 20, 22 fit onto a conduit end T that is received by the body 12.

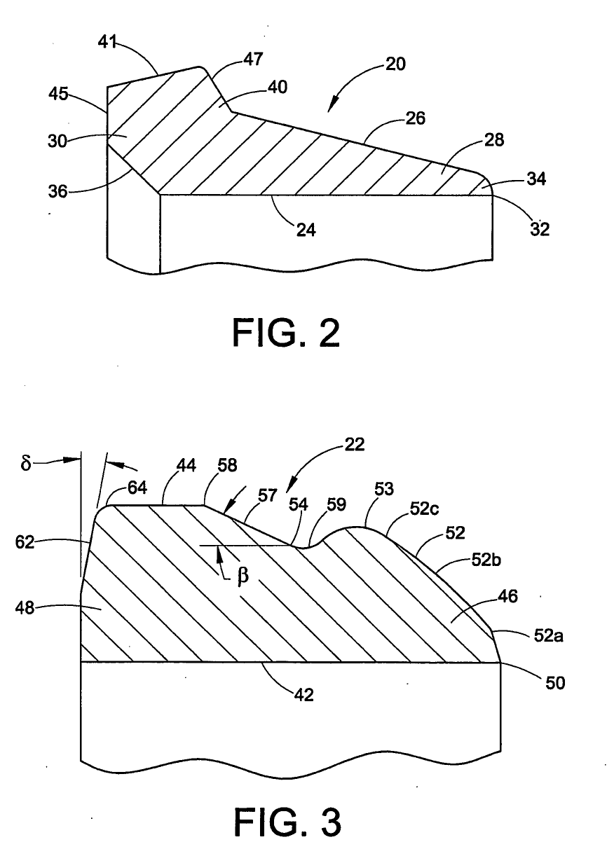

FIG. 2 is an enlarged cross section of a first or front ferrule of the exemplary fitting shown in FIG. 1. The first ferrule 20 is a generally annular part with a generally cylindrical interior wall 24 that slips over the outer surface S of the tube end T (see FIG. 1). The first ferrule 20 has an outer surface 26 that tapers outwardly in a generally conical manner from a forward portion 28 to a rearward portion 30. The forward portion 28 may include a sharp front edge 32 and a rounded nose portion 34. In another embodiment, the sharp front edge 32 is replaced with a rounded surface. The rearward portion 30 includes a frusto-conical recess 36 that forms a camming surface. The tapered outer surface 26 may converge with a radially outward extending flange 40. An outer surface 41 of the flange 40 is tapered such that a thickness of the flange gradually increases from a rear surface 45 of the ferrule 20 toward a front surface 47 of the flange 40.

FIG. 3 is an enlarged cross section of the second or back ferrule 22 of the exemplary fitting shown in FIG. 1. The second ferrule 22 is a generally annular part with a generally cylindrical interior wall 42 that slips over the outer surface S of the tube end T (see FIG. 1). The second ferrule 22 further includes a nose portion 46 and an axially extending outer surface 44 that extends about a rearward portion 48 of the ferrule. The nose portion 46 may include an optional sharp front edge 50 and a first contoured portion 52 that extends toward the rear portion 48 from the sharp edge 50. The first contoured portion 52 may be formed by multiple convex surfaces that are blended together (See FIG. 3). For example, the first contoured portion 52 may be defined by a first relatively small radius 52a near the front edge, a relatively larger radius 52b that is blended with the first relatively small radius 52a, and a second relatively small radius 52c that is blended with the relatively larger radius 52b. In one embodiment, the relatively larger radius is at least three times the first relatively small radius and the second relatively small radius. For example, the relatively larger radius may be about four times the first relatively smaller radius and the second relatively smaller radius. The first contoured portion includes a hump 53. The first contoured portion 52 merges or blends with a second contoured portion 54 that forms a concave surface. The second contoured portion 54 merges or blends with the axial portion 44 at a corner or edge 58 which may alternatively be a radius. The second contoured portion 54 may include a taper 57 and a concave radius 59 that is blended with the concave radius. The taper 57 extends at an angle β, such as between about thirty and about thirty-five degrees, for example.

The rearward portion 48 has a driven surface 62. The driven surface 62 extends radially outwardly at an angle δ, such as about five degrees (referenced from normal to a central axis X of the fitting), for example. The driven surface 62 merges or blends with the axial portion 44 along a curved portion 64.

Referring to FIG. 1, the nut 16 has a central bore 66 that receives the tube end T during assembly. The nut 12 defines ferrule recesses 70, 71. The recess 70 is defined by a cylindrical portion 72 and a frusto-conical portion 74 that tapers radially inwardly toward a back end 75 of the nut 12. Referring to FIG. 1A, the frusto-conical portion 74 forms a drive surface that contacts the driven surface 62 of the second or back ferrule during pull-up. The drive surface 74 is formed at an angle τ (see FIG. 1A), such as about fifteen degrees, for example. Because the angle τ is different from the angle δ (See FIG. 3), the driven surface 62 of the back ferrule 22 initially contacts the drive surface 74 at the curved portion 64. The difference angle Φ, where Φ=τ−δ, assures that the initial contact between the nut 16 and the second ferrule 22 is radially spaced from the tube end T. Thus, the contact between the driven and the drive surfaces 62, 74 is not a flush. The recess 70 is sized to retain the back ferrule 22. The recess 71 extends radially outward from the recess 70 and is sized to retain the flange portion 40 of the front ferrule 20 therein.

The nut 16 further includes a tool engagement portion 80 that allows a torque wrench or other tool to be used to tighten and pull-up the fitting 10. The tool engagement portion 80 in the exemplary embodiment of FIG. 1 is realized as a hex portion. The tool engagement portion 80 can be formed in variety of ways.

With reference to FIG. 1, the male threaded body 16 is a generally cylindrical part centered on the axis X. The body 16 has an opening 83 at a forward end 84 adapted to receive the tube end T. A central bore 86 extends through the body 12 and forms a port which defines a fluid flow path. The port may be used to establish fluid communication with another part such as a valve, tee, elbow, manifold, etc. It should be noted that although the male threaded fitting component 16 is shown as a separate stand alone part, the features of the component by which it can make a fluid connection with the female threaded fitting component could, alternatively, be incorporated into a bulk body such as a manifold, valve, pump, tank, and so on, commonly referred to as a fluid port.

The opening 83 includes a counterbore 89 that forms a shoulder 90. The tube end T bottoms against the shoulder 90 when received by the body 12. The counterbore 89 may have a slight taper to it to help form a seal about the tube end T upon pull-up of the fitting 10. The opening 83 of the male fitting component 16 further includes a tapered surface, such as for example frusto-conical surface 92. The frusto-conical surface 92 forms a ferrule camming surface in the body 12 and may be axially adjacent the forward end of the counterbore 89. The ferrule camming surface 92 is formed at an angle σ (See FIG. 1A). The angle σ may be selected to optimize the camming action with the nose portion 34 of the first ferrule 20. In typical two ferrule fittings, this angle a is about twenty degrees but may be any suitable value from about ten degrees to about forty-five degrees.

The body 16 includes male threads 18 which threadably mate with female threads, 14 of the female nut 12. It should be noted that the body 16 may also be formed into a cap by closing off or eliminating the port 86. Such a cap can be used to cap the end of a fluid line. The body 16 may be provided with hex flats to facilitate holding the body while the nut 12 is being tightened down during pull-up. Of course, pull-up involves relative axial translation between the fitting components, the nut 12 and body 16, in this case is effected by relative rotation between the nut and body, regardless of which fitting component is being held and which is being turned. In a non-threaded coupling, pull-up involves relative axial translation between the two fitting components by means other than two threaded components, such as for example two components forced together by a clamping device.

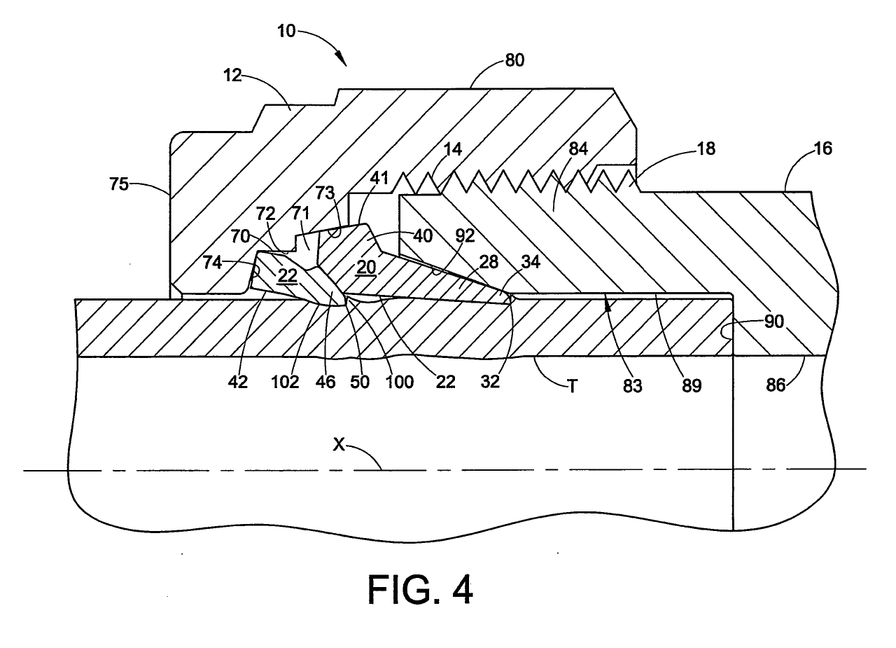

FIGS. 1 and 4 illustrate the fitting 10, in a finger tight condition and a pulled-up condition, respectively. In the finger tight condition of FIG. 1, the front ferrule nose portion 28 is positioned partially within the camming surface formed by the ferrule camming surface 92. The back ferrule 22 engages the drive surface 74 of the nut 16 at the difference angle as described above. This assures that during pull-up the back end portion 60 of the second ferrule 22 will move or remain radially outward from the outer surface S of the tube end T. Referring to FIG. 4, at the same time, the nose portion 46 of the back ferrule 22 is plastically deformed so that the sharp edge 50 bites or indents into the tube surface S, producing a strong tube gripping shoulder 100 and a fluid tight seal. The ferrule nose 46 also hinges so that a portion 102 of the cylindrical wall 42 is radially compressed against the tube wall surface S to swage or collet the back ferrule 22 against the surface axially spaced from the bite 100. This region of high radial compression and colleting of the back ferrule 22 provides excellent protection of the bite or indent 100 from vibration. The back ferrule 22 thus is designed to hinge in deformation and effect upon pull-up the colleting region 102 between the bite or indent 100 and the back end 60 of the ferrule while having the back end portion 60 moved radially outward or kept radially outward from the outer surface S of the tube end T. The exact location of the colleting region 102 will be determined by, among other things, the size of the ferrule 22. In some cases, the collet region 102 can be adjacent the bite or indent 100 while in other cases the colleting region may occur axially spaced from the bite or indent. The collet region 102 may in some case be further characterized by a convex profile that swages the tube end.

The primary functions of the ferrules 20, 22 are to create fluid tight seals and tube grip, along with resistance to vibration from outboard system induced vibration. The front ferrule 20 is used primarily to provide a fluid tight seal against the body 12 and the tube outer surface S, while the back ferrule 22 is used for a back-up seal against the tube outer surface S and to provide excellent tube grip. The particular geometry and operation of the ferrules can be selected as required for a particular application and dependent on the types of materials being used. The back ferrule 22, for example, may be provided with one or more recesses in the interior cylindrical wall 42 of the ferrule, and the driven surface 62 of the ferrule may be contoured. Still further, one or both of the ferrules 20, 22 may be case hardened, for example by a low temperature carburization process to provide very hard ferrules that are corrosion resistant. The case hardening may be applied over a portion or all of the ferrule surface. A number of issued patents disclose such case hardening and geometry concepts that may be applied to the ferrules, such as U.S. Pat. Nos. 6,629,708; 6,547,888; 6,165,597; and 6,093,303 issued to the assignee of the present invention, the entire disclosures of which are fully incorporated herein by reference, as well as PCT International Publication Nos. WO 02/063195A2 and WO 02/063194A3 also incorporated herein by reference. Such patents and applications and the concepts therein, however, are exemplary in nature as to the present invention and should not be construed in a limiting sense. Many different case hardening processes and a wide variety of geometric configurations may be used to properly control the plastic deformation of the ferrules during pull-up to assure adequate seal and tube grip. The fitting 10 may withstand higher pressures when the ferrules 20, 22 are case hardened, such as for example, carbonized. This allows the ferrules 20, 22 to bite and seal against work hardened conduits such as for example heavy walled tubing, 1/8 hard or strain hardened material, stainlesss steel, such as 316, 304, and 6Moly SS, or duplex stainless steel, such as 2205, 2507; that is needed for higher pressure applications.

Under elevated pressures, the tube wall will tend to be radially expanded, pushing outward on the ferrules 20, 22. The wall 73 of the recess 71 serves to radially contain the front ferrule 20 and the wall 72 of the recess 70 serves to radially contain the rear ferrule 22. The wall 73 of the recess 71 engages the flange 40 of the front ferrule 20 to radially contain the front ferrule 20.

In the embodiment illustrated by FIGS. 1 and 4, the wall 72 of the recess 70 is cylindrical and forms a socket for the back ferrule 22 and the wall 73 of the recess 71 is tapered or frusto-conical and forms a tapered socket for the radially extending flange 40 of the front ferrule 20. The tapered socket provides for easier withdrawal of the nut 12 during disassembly because the flange 40 of the front ferrule 20 can disengage from contact with the wall 73 during withdrawal of the nut. In another embodiment, the wall 72 of the recess 70 is also tapered to further ease withdrawal of the nut during disassembly. Referring to FIG. 1A, the wall 73 may taper at an angle ε of about five to about twenty degrees relative to a central longitudinal axis X but other angles may be used. The tapered surface 41 of the radially extending flange also helps to facilitate disassembly. The tapered surface 41 may be formed at an angle suitable to achieve the desired effect, for example, about five to about twenty degrees relative to the axis X, but other angles may be used.

Referring to FIG. 1A, the wall 73 of the recess 71 is formed at an angle relative to the central longitudinal axis X of the fitting. The tapered surface 41 of the radially extending flange 40 is formed at an angle μ relative to the longitudinal axis X. The angle μ may be equal or about equal to the angle ε, but in some cases it will be desirable to have μ≠ε. For example, typically the back end of the front ferrule tends to move radially away from the tube wall T and/or rotate during pull-up due to forces applied by the back ferrule 22. By including a difference angle ω=μ−ε, the surface 41 will contact the wall 73 over a greater surface area, thus reducing stress concentrations to help reduce the likelihood of the front ferrule galling the surface. The difference angle w between the tapered surface 41 and the cylindrical wall 73 diminishes gradually as the fitting is pulled up. When the fitting reaches the pulled up position, the tapered surface 41 and the wall are substantially aligned in the exemplary embodiment. In an exemplary embodiment, the difference angle ω is eliminated upon pull up and the surface 41 becomes aligned with the surface of the wall 73 and engagement is substantially flush. The angle ω may be any suitable angle, such as for example two degrees, but may be greater or less than two degrees for a particular design. The flange 40 contacts the wall 73 upon pull up and the wall 43 thus acts as a load bearing surface to support the ferrule 20 under high pressure. The radially extending flange 40 also provides more bulk to the front ferrule, helping it to withstand higher pressures and to help contain the back ferrule at higher pressures.

In one embodiment, the nut 12, and in particular the interior surface may be case hardened such as by using the processes described herein above or other suitable case hardening processes. The processes described herein above in the incorporated references are especially well suited as they provide excellent corrosion resistance and very hard surfaces. In some applications the entire nut may be case hardened. The case hardened surface, especially a low temperature carburized surface for example, may also eliminate the need for expensive lubricants because a simple oil or other suitable lubricant can be used with the oxide formed on the case hardened surfaces.

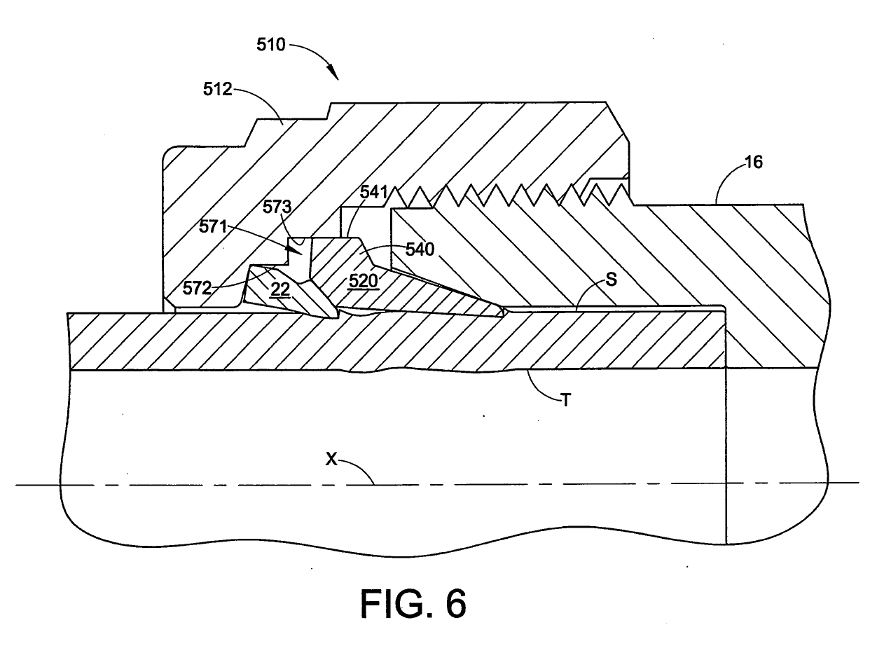

FIGS. 5, 5A and 6 illustrate a second embodiment of a fitting 510. The fitting 510 is similar to the fitting 10 illustrated in FIGS. 1, 1A and 4, except the frusto-conical wall 73 is replaced with a cylindrical wall 573. The front ferrule 520 is configured to interact with the cylindrical wall 573 instead of the frusto-conical wall 73 as explained below. The remaining components of the fitting 510 may be configured in the same manner as the fitting 10. As such, details of these components of the fitting 510 are not described again in detail.

Under elevated pressures, the tube wall will tend to be radially expanded, pushing outward on the ferrules 520, 22. A wall 573 of a recess 571 serves to radially contain the front ferrule 20 and a wall 572 of a recess 570 serves to radially contain the rear ferrule 22. The wall 573 of the recess 571 engages a flange 540 of the front ferrule 520 to radially contain the front ferrule 520.

In the embodiment illustrated by FIGS. 5 and 6, the walls 572, 573 are cylindrical and form sockets for the ferrules 520, 22. A tapered surface 541 of the radially extending flange 540 is formed at an angle μ relative to the longitudinal axis X. Typically the back end of the front ferrule 522 tends to move radially away from the tube wall T and/or rotate during pull-up due to forces applied by the back ferrule 522. As a result, the difference angle μ between the tapered surface 541 and the cylindrical wall 573 diminishes gradually as the fitting is pulled up. When the fitting reaches the pulled up position, the tapered surface 541 and the cylindrical wall are substantially aligned in the exemplary embodiment. By including a difference angle μ, the surface 541 will contact the cylindrical wall 573 over a greater surface area, thus reducing stress concentrations. In an exemplary embodiment, the difference angle μ is eliminated upon pull up and the surface 541 becomes aligned with the surface of the wall 573 and engagement is substantially flush. The angle μ may be any suitable angle, such as for example two degrees, but may be greater or less than two degrees for a particular design. The flange 540 contacts the wall 573 upon pull up and the wall 543 thus acts as a load bearing surface to support the ferrule 522 under high pressure.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. A tube fitting comprising:
a first fitting component comprising a rear ferrule recess and a front ferrule recess;
a second fitting component having a front ferrule camming surface;
a front ferrule disposed between the first fitting component and the second fitting component such that a portion of the front ferrule engages the front ferrule camming surface, the front ferrule includes a flange that extends radially outward from the portion of the front ferrule that engages the front ferrule camming surface, wherein a difference angle is presented between a radially outer surface of the front ferrule recess and an outer surface of the flange when the fitting is in a finger tight condition and wherein said difference angle diminishes during pull up of the fitting;
a rear ferrule disposed between the front ferrule and the first fitting component such that a rear ferrule drive surface of the rear ferrule recess engages the rear ferrule when the fitting is pulled up.

2. The tube fitting of claim 1 wherein a circumferential wall of the front ferrule recess and the outer surface of the flange are substantially aligned when the fitting is in a pulled-up condition.

3. The tube fitting of claim 1 wherein the first fitting component is a female nut.

4. The tube fitting of claim 1 wherein the outer surface of the flange engages a circumferential wall of the front ferrule recess when the fitting is pulled up.

5. The tube fitting of claim 1 wherein the front ferrule recess is cylindrical.

6. The tube fitting of claim 1 wherein the front ferrule recess is frusto-conical.

7. The tube fitting of claim 5 wherein the rear ferrule recess is cylindrical.

8. The tube fitting of claim 5 wherein the rear ferrule recess is frusto-conical.

9. The tube fitting of claim 6 wherein the rear ferrule recess is cylindrical.

10. The tube fitting of claim 6 wherein the rear ferrule recess is frusto-conical.

11. A tube fitting comprising:
a first fitting component having a rear ferrule drive surface, a first circumferential wall axially extending from the ferrule drive surface, and a second circumferential wall disposed radially outward of the first circumferential wall and that extends axially from the first circumferential wall;
a second fitting component having a front ferrule camming surface;
a front ferrule disposed between the first fitting component and the second fitting component such that a portion of the front ferrule engages the front ferrule camming surface, the front ferrule includes a flange that extends radially outward from the portion of the front ferrule that engages the front ferrule camming surface, wherein a difference angle is defined between the second circumferential wall and an outer surface of the flange when the fitting is in a finger tight condition and wherein said difference angle diminishes during pull up of the fitting;
a rear ferrule disposed between the front ferrule and the first fitting component such that the rear ferrule drive surface engages the rear ferrule when the fitting is pulled up.

12. The tube fitting of claim 11 wherein the second circumferential wall and the outer surface of the flange are substantially aligned when the fitting is in a pulled-up condition.

13. The tube fitting of claim 11 wherein the first fitting component is a female nut.

14. The tube fitting of claim 11 wherein the outer surface of the flange engages the second circumferential wall when the fitting is pulled up.

15. The tube fitting of claim 11 wherein the second circumferential wall is cylindrical.

16. The tube fitting of claim 11 wherein the second circumferential wall is frusto-conical.

17. The tube fitting of claim 15 wherein the first circumferential wall is cylindrical.

18. The tube fitting of claim 15 wherein the first circumferential wall is frusto-conical.

19. The tube fitting of claim 16 wherein the first circumferential wall is cylindrical.

20. The tube fitting of claim 16 wherein the first circumferential wall is frusto-conical.

21. A tube fitting comprising:
a female nut having a ferrule drive surface and at least one interior circumferential wall;
a male fitting component having a front ferrule caroming surface;
a front ferrule disposed between the female nut and the male fitting component such that a portion of the front ferrule engages the front ferrule camming surface, the front ferrule includes a flange that extends radially outward from the portion of the front ferrule that engages the front ferrule camming surface, wherein a difference angle is defined between the interior circumferential wall and an outer surface of the flange when the fitting is in a finger tight condition and wherein said difference angle diminishes during pull up of the fitting;
a rear ferrule disposed between the front ferrule and the female nut such that the drive surface engages the rear ferrule when the fitting is pulled up.

22. The tube fitting of claim 21 wherein the interior circumferential wall and the outer surface of the flange are aligned when the fitting is in a pulled up condition.

23. The tube fitting of claim 21 wherein the outer surface of the flange engages the interior circumferential wall when the fitting is pulled up.

24. The tube fitting of claim 21 wherein the interior circumferential wall is cylindrical.

25. The tube fitting of claim 21 wherein the interior circumferential wall is frusto-conical.

26. A tube fitting comprising:
a first fitting component having a ferrule drive surface and at least one cylindrical interior wall;
a second fitting component having a ferrule camming surface;
a ferrule disposed between the first fitting component and the second fitting component such that a portion of the ferrule engages the ferrule camming surface when the fitting is in the pulled up condition, the ferrule includes a flange that extends radially outward from the portion of the ferrule that engage the ferrule camming surface, wherein a difference angle is defined between the cylindrical interior wall and an outer surface of the flange when the fitting is in a finger tight condition and wherein said difference angle diminishes during pull up of the fitting.

27. The tube fitting of claim 26 wherein the outer surface of the flange is aligned with the cylindrical interior wall when the fitting is in the pulled up condition.

28. The tube fitting of claim 26 further comprising a second ferrule disposed between the first fitting component and the second fitting component.

29. The tube fitting of claim 26 wherein the outer surface of the flange engages the cylindrical wall when the fitting is pulled up.
